(19) United States
(12) Patent Application Publication
(10) Pub. No.: US 2005/0025078 A1
(43) Pub. Date: Feb. 3, 2005

(54) Data transmission system, data transmission method, information processor and pointer

(75) Inventor: Sang-chul Hwang, Seoul City (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/875,795

(22) Filed: Jun. 25, 2004

(30) Foreign Application Priority Data
Jul. 9, 2003 (KR) 2003-46376

(51) Int. Cl. H04B 7/00

(52) U.S. Cl. 370/310

(57) ABSTRACT

The present invention relates to a data transmission system having a first information processor and a second information processor connected with each other through a network and having touch screen interfaces; and a pointer that wirelessly sends data to and/or receives data from the first information processor and the second information processor, wherein the first information processor transmits address information of previously stored data to the pointer, the data corresponding to a first touch signal input through the touch screen interface, the pointer stores the address information received from the first information processor and transmits the stored address information to the second information processor, if an address requesting signal is received from the second information processor, and the second information processor receives stored data from the first information processor and stores the received data, the stored data corresponds to the address information received from the pointer. Thus, In the present invention, a process to set up an network environment is not required as in the conventional data transmission system using the conventional Windows Explorer, so that a normal user having minimal knowledge of networking can transmit data more easily. Moreover, even if the user doesn't know the exact IP address information of the information processor storing data to be transmitted or the directory in which a file is stored, the user can transmit data. Further, only the address information of the stored data to be transmitted is stored in the pointer, so that the address storage of the pointer has a greater storage capacity. Data transmission between information processors placed far from each other is accomplished with ease by using the pointer which is easily carried.

### CROSS-REFERENCE TO RELATED APPLICATIONS

This application claims the benefit of Korean Patent Application No. 2003-46376, filed Jul. 09, 2003, in the Korean Intellectual Property Office, the disclosure of which is incorporated herein by reference.

### BACKGROUND OF THE INVENTION

1. Field of the Invention

The present invention relates to a data transmission system, a data transmission method, an information processor, and a pointer, and more particularly to a data transmission system, a data transmission method, an information processor, and a pointer which provide a user with a convenient interface to transmit stored data between information processors using a pointer that wirelessly sends data to and/or receives data from the information processors.

2. Description of the Related Art

Information processors such as portable computers, laptop computers, PDAs (personal digital assistants), tablet computers, and the like, and desktop computers are not only used to process information, but are also widely used to transmit data to each other through networks using network techniques such as the Internet and the like.

FIG. 1 shows an example of a data transmission network of information processors using Windows Explorer, which is provided by Microsoft® Windows. If Using Windows Explorer, a user selects the network tab to display file information of other computers connected to the network. The user can then send files to and/or receive files from the other computers by dragging and dropping the files using a mouse or a similar device.

A network environment must be previously set up for conventional data transmission. For example, a driver for a network must be installed between computers connected through the network, a name on the network indicating each computer must be determined, a sharing directory must be set up in each computer, and so on. A normal user having minimal network knowledge may have difficulty in setting up a network environment.

Even if the network environments are set up as described above, data transmission using Windows Explorer only works for file transmission between computers having the same gateway. Windows Explorer cannot be used to transmit data between computers having different gateways.

Moreover, if Windows Explorer is used with a plurality of computers having the same gateway, the computer in which the Windows Explorer is used collects information about all of computers having the same gateway. In some cases, a great deal of time may be taken to collect and display information from each computer. Therefore, if the user wants to transmit a file to a specific computer, unnecessary time is taken.

Alternate methods such as an application supplying FTP (File Transfer Protocol) can also be used to transmit data between computers connected through a network. However, a normal user having little knowledge of networks may have difficulty in using it. To use FTP, the user must know the exact IP address of a partner to use the above method.

### SUMMARY OF THE INVENTION

Accordingly, it is an aspect of the present invention to provide a data transmission system, a data transmission method, an information processor, and a pointer which provides a convenient user interface to transmit stored data between information processors by using a pointer that wirelessly sends data to and/or receives data from the information processors.

Additional aspects and/or advantages of the present invention will be set forth in part in the description which follows and, in part, will be obvious from the description, or may be learned by practice of the invention.

The foregoing and/or other aspects of the present invention are achieved by providing a data transmission system comprising: a first information processor and a second information processor connected with each other through a network, the information processors optionally having touch screen interfaces; and a pointer that wirelessly sends data to and/or receive data from the first information processor and the second information processor, wherein the first information processor transmits address information of previously stored data to the pointer, the data corresponding to a first touch signal input through the touch screen interface, the pointer stores the address information received from the first information processor, and, if an address requesting signal is received from the second information processor, transmits the stored address information to the second information processor, and the second information processor receives stored data from the first information processor and stores the received data, the stored data corresponding to the address information received from the pointer.

According to an aspect of the present invention, the first information processor comprises: a first data storage to store at least one data; a first wireless network module to transmit the address information; and a first transmission controller to read the address information of the data corresponding to the first touch signal and transmit the read address information through the first wireless network module.

According to an aspect of the present invention, the first transmission controller is an application based on an operating system of the first information processor.

According to an aspect of the present invention, the second information processor comprises: a second wireless network module to receive address information transmitted from the pointer; a second transmission controller to transmit the address requesting signal through the second wireless network module, corresponding to the second touch signal input through the touch screen interface; and a second data storage to store the stored data transmitted from the first information processor.

According to an aspect of the present invention, the second transmission controller is an application based on an operating system of the second information processor.

According to an aspect of the present invention, the second transmission controller of the second information processor transmits the address requesting signal through the second wireless network module, corresponding to a second touch signal input through the touch screen interface of the second information processor.

According to an aspect of the present invention, the second transmission controller of the second information processor transmits a stored data requesting signal to the first information processor, if the address information is received from the pointer, to request transmission of the stored data corresponding to the received address information.

According to an aspect of the present invention, the pointer comprises: a third wireless network module that wirelessly sends data to and/or receive data from the first wireless network module and the second wireless network module; an address storage to store address information received from the first information processor through the third wireless network module; and a third transmission controller to sense when the address requesting signal is received from the second information processor through the third wireless network module and transmit the address information stored in the address storage to the second information processor through the third wireless network module.

According to an aspect of the present invention, if the third transmission controller senses that the address requesting signal is received the third transmission controller reads out and transmits the address information stored most recently among the address information stored in the address storage.

According to an aspect of the present invention, the second transmission controller transmits an address list requesting signal through the second wireless network module corresponding to a third touch signal input through the touch screen interface of the second information processor, and if the address list requesting signal is received, the third transmission controller reads and transmits all of address information stored in the address storage.

According to an aspect of the present invention, the second transmission controller displays a list of address information received from the pointer, corresponding to the address list requesting signal, and transmits the stored data requesting signal to the first information processor to request transmission of the stored data corresponding to the address information selected through the touch screen interface of the second information processor.

According to an aspect of the present invention, the first information processor, the second information processor, and the pointer wirelessly send and/or receive data using a Bluetooth protocol and/or a wireless LAN protocol.

According to an aspect of the present invention, the network connecting the first information processor and the second information processor supports a TCP/IP protocol.

According to an aspect of the present invention, the address information comprises IP address information of the stored data corresponding to the address information, directory information in the first information processor, and file information of the stored data.

The foregoing and/or other aspects of the present invention are achieved by providing a method of transmitting data between a first information processor and a second information processor connected to each other through a network and having touch screen interfaces to input a touch signal therein, the data transmission method comprising: providing a pointer that wirelessly sends data to and/or receive data from a first information processor and the second information processor; inputting a first touch signal to transmit address information through the touch screen interface of the first information processor; transmitting address information of stored data to the pointer, the stored data corresponding to the first touch signal among data previously stored in the first information processor; storing the transmitted address information in the pointer; transmitting the stored address information to the second information processor according to a request from the second information processor; transmitting the data stored in the first information processor that corresponds to the transmitted address information to the second information processor; and storing the stored data transmitted from the first information processor in the second information processor.

According to an aspect of the present invention, the transmitting of the stored address information to the second information processor comprises: inputting a second touch signal through the touch screen interface of the second information processor to request transmission of the address information stored in the pointer; transmitting an address requesting signal corresponding to the second touch signal from the second information processor to the pointer; and transmitting the address information stored in the pointer from the pointer to the second information processor if the address requesting signal is received into the pointer.

According to an aspect of the present invention, the address information stored most recently in the pointer and corresponding to the address requesting signal is transmitted from the pointer to the second information processor in the transmitting of the address information stored in the pointer from the pointer to the second information processor.

According to an aspect of the present invention, the transmitting of the stored address information to the second information processor comprises: inputting a third touch signal through the touch screen interface of the second information processor; transmitting an address list requesting signal from the second information processor to the pointer that corresponds to the second touch signal; and, if the address list requesting signal is received into the pointer transmitting all of address information stored in the pointer from the pointer to the second information processor.

According to an aspect of the present invention, the data transmission method further comprises: receiving address information that corresponds to the address list requesting signal into the second information processor from the pointer; displaying a list of the received address information; and selecting at least one address information from the list of the displayed address information, wherein the stored data transmitted from the first information processor to the second information processor in the comprises the stored data corresponding to the address information selected.

According to an aspect of the present invention, the transmitting the data stored in the first information processor, that corresponds to the transmitted address information, to the second information processor comprises: receiving address information transmitted from the pointer into the second information processor; transmitting a data requesting signal to the first information processor to request transmission of data stored in the first information processor the data corresponding to the received address information; and transmitting stored data that corresponds to the data requesting signal from the first information processor to the second information processor.

According to an aspect of the present invention, the address information comprises IP address information of the stored data that corresponds to the address information, directory information in the first information processor, and file information of the stored data.

The foregoing and/or other aspects of the present invention are achieved by providing an information system comprising both a system main body and a pointer. The system main body comprises: a first wireless network module; a touch screen interface to input a touch signal therein, a data storage to store at least one data therein, and a first transmission controller to transmit address information of stored data through the first wireless network module, the stored data corresponding to the touch signal input through the touch screen interface. The pointer comprises: a second wireless network module that sends data to and/or receives data from the first wireless network module; an address storage to store address information received from the second wireless network module; and a second transmission controller to read address information stored in the address storage according to the request of an external information processor and transmit the address information to the external information processor.

According to an aspect of the present invention, if there is a request of the external information processor that receives the address information from the pointer the first transmission controller reads stored data that corresponds to the address information from the data storage and transmits the read data to the external information processor.

The foregoing and/or other aspects of the present invention are achieved by providing a pointer comprising: a wireless network module that wirelessly sends data to and/or receive data from a first information processor and a second information processor; an address storage to store address information of data stored in the first information processor, the address information being received from the first information processor through the wireless network module; and a transmission controller to transmit the address information stored in the address storage to the second information processor through the wireless network module if address requesting signal is received from the second information processor through the wireless network module.

According to an aspect of the present invention, the wireless network module supports a Bluetooth protocol.

### BRIEF DESCRIPTION OF THE DRAWINGS

These and/or other aspects and advantages of the present invention will become apparent and more readily appreciated from the following description of the embodiments, taken in conjunction with the accompanying drawings of which:

FIG. 1 shows a Windows Explorer window of a conventional Windows operating system;

FIG. 2 is a control block diagram of an information processor according to an embodiment of the present invention;

FIG. 3 is a control block diagram of a Bluetooth network module;

FIG. 4 is a control block diagram of a pointer according to an embodiment of the present invention;

FIG. 5 shows a structure of a data transmission system according to an embodiment of the present invention;

FIG. 6 is a control flow chart showing a data transmission method according to an embodiment of the present invention:

FIG. 7 is a control flow chart showing a data transmission method according to another embodiment of the present invention;

FIGS. 8 and 9 show examples of user interfaces to transmit data in the information processor according to various embodiments of the present invention.

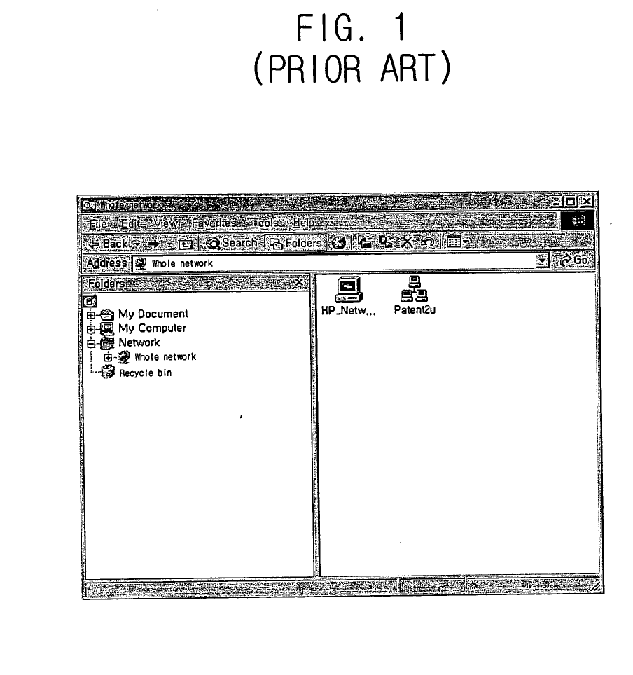

### DETAILED DESCRIPTION OF THE PREFERRED EMBODIMENTS

Reference will now be made in detail to the embodiments of the present invention, examples of which are illustrated in the accompanying drawings, wherein like reference numerals refer to like elements throughout. The embodiments are described below in order to explain the present invention by referring to the figures.

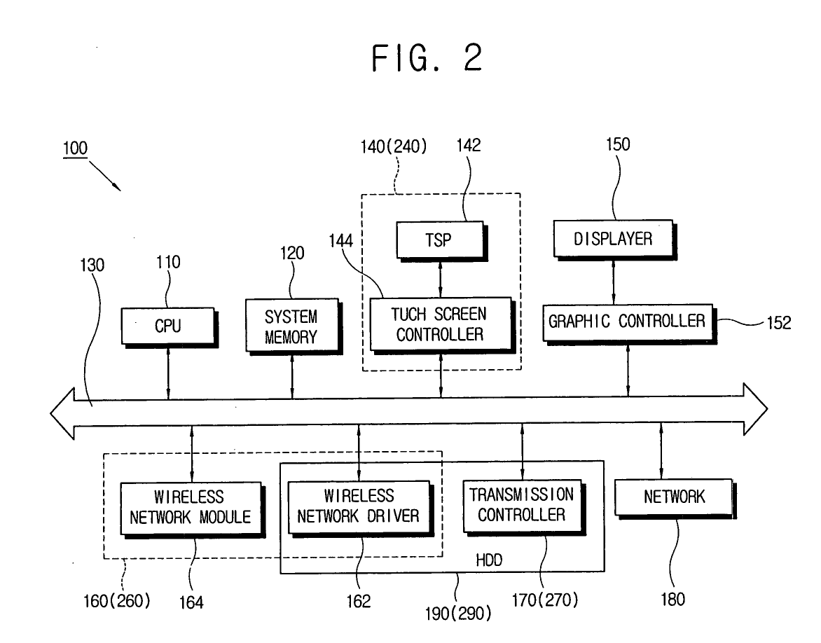

As shown in FIG. 2, an information processor 100 according to an embodiment of the present invention comprises: a CPU (central processing unit) 110, a system memory 120, an auxiliary storage module such as a hard disc drive 190 and the like, a display 150 to display pictures, a graphic controller 152 to transmit a video signal to the display 150 and a system bus 130 connecting the components to each other. The CPU 110, the system memory 120, and the system bus 130 are components that serve to control and operate the information processor. According to control of the CPU 110, data are moved through the system bus 130, processed, and operated, thereby performing a system function.

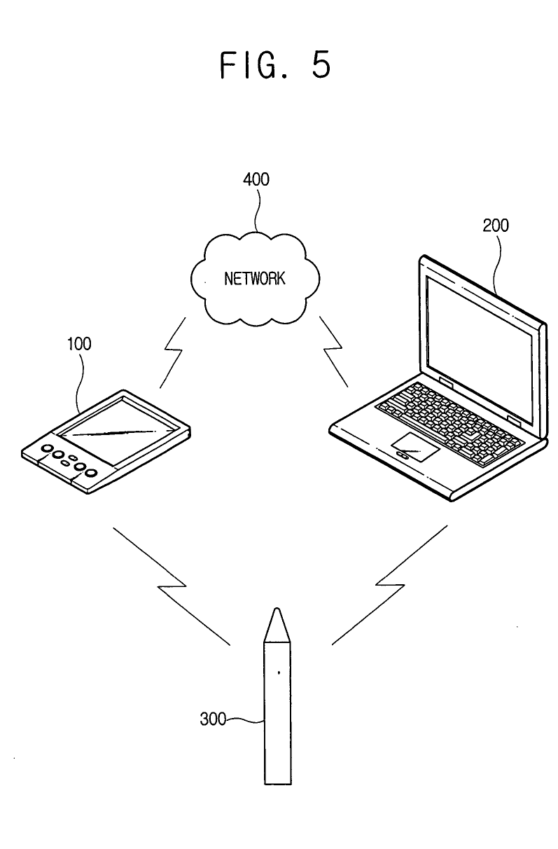

The information processor 100, according to an embodiment of the present invention, further comprises: a touch screen interface 140 to input a touch signal thereon through the display 150, a wireless network module 160 to wirelessly send data to and/or receive data from a pointer 300 (described later, refer to FIG. 5), and a transmission controller 170 to wirelessly send data to and/or receive data from the pointer 300 through the wireless network module 160, based on the touch signal input through the touch screen interface 140.

The touch screen interface 140 comprises: a touch screen pad (TSP) 142, mounted on the display 150, and a touch screen controller 144 to output the touch signal according to an external input supplied through the touch screen pad 142. Examples of the external input are a touch having a predetermined pressure and an input of light. The touch screen controller 144 outputs a touch signal according to a position data corresponding to the supplied external input.

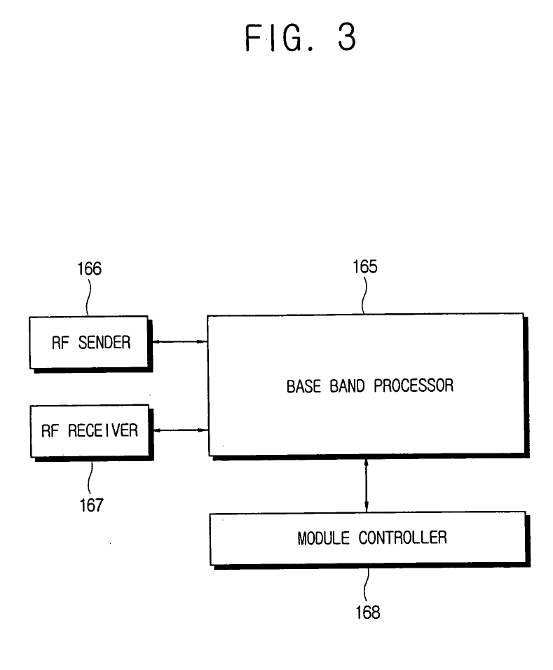

The wireless network module 160 of the information processor 100 sends data to the pointer 300 and/or receives data from the pointer 300. In an aspect of the present invention, the wireless network module 160 comprises a wireless network unit 164, a hardware component, and a wireless network driver 162, a software component. The wireless network module 160 according to an embodiment of the present invention may send and/or receive data using a Bluetooth protocol. In an aspect of the present invention, the wireless network module 160 comprises a Bluetooth network module connected with the system bus 130 and a Bluetooth network driver to control the Bluetooth network module. FIG. 3 illustrates an example of an inner structure of the Bluetooth network module according to the present invention. The Bluetooth network module comprises: a RF sender 166 and a RF receiver 167 to send and/or receive a data packet according to a standard of the Bluetooth protocol, a base band processor 165 to modulateand/or demodulate a signal receivedfrom and/or sent to the RF sender 166 and the RF receiver 167, and a module controller 168 to control the operation of the module. The Bluetooth network driver is stored by being installed in the auxiliary storage module 190.

The transmission controller 170 of the information processor 100 controls the wireless sending of data to and/or receiving of data from the pointer 300 and the transmission of stored data to another information processor, based on the touch signal inputted through the touch screen interface 140. The transmission controller 170, according to an embodiment of the present invention, comprises an application based on the operation system of the information processor. The transmission controller 170 is stored by being installed in the auxiliary storage module 190.

The information processor 100, according to an embodiment of the present invention, comprises a network 180 to connect the information processor 100 to another information processor. The network 180, according to an embodiment of the present invention, supports TCP/IP (Transmission Control Protocol/Internet Protocol). If the network 180 supplies TCP/IP, wire and/or wireless protocols such as a wire LAN (Local Area Network), the Bluetooth protocol, and/or the like can be applied.

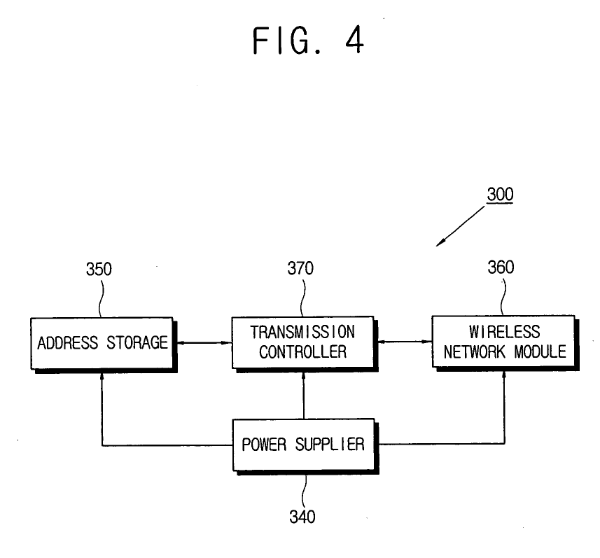

FIG. 4 is a control block diagram of the pointer 300 according to an embodiment of the present invention. As shown herein, the pointer 300 comprises; a wireless network 360 to wirelessly send data to and/or receive data from the wireless network module 160 of the information processor 100, an address storage 350 to store address information of stored data received from the information processor 100, a transmission controller 370 to control sending of data to and/or receiving of data from the information processor 100, and a power supplier 340 to supply electric power to the wireless network 360, the address storage 350, and the transmission controller 370.

The wireless network 360 of the pointer 300 supports the same wireless network protocol as the wireless network module 160 of the information processor 100, thereby enabling to wirelessly send data to and/or receive data from the wireless network module 160 of the information processor 100. For example, if the wireless network module 160 of the information processor 100 supports the Bluetooth protocol as described above, the wireless network 360 of the pointer 300 also supports the Bluetooth protocol.

The address storage 350 of the pointer 300 is a memory which is read from and/or written to, and in which address data received from the information processor 100 through the wireless network 360 are stored. Here, the address storage 350 may comprise a Non-Volatile Memory (NVM), such as a Flash memory or EEPROM, and/or a RAM (Random Access Memory) to temporarily store and/or process data generated when the pointer 300 is operated.

The transmission controller 370 of the pointer 300 stores address information transmitted from the information processor 100 in the address storage 350 and transmits the whole or a part of the address information stored in the address storage 350 to the outside through the wireless network module 360, responding to an external request. According to an embodiment of the present invention, the transmission controller 370 of the pointer 300 is firmware stored in a chip in the form of a module, or as a program storing control data. The control of the transmission controller 370 will be described later.

FIG. 5 illustrates a structure of a data transmission system according to an embodiment of the present invention. As shown herein, the data transmission system comprises information processors 100 and 200 and the pointer 300 as previously described.

The information processors 100 and 200 are connected to each other through the network 400, thereby enabling them to send and/or receive data. That is, the information processors 100 and 200 are connected to each other through the network 180 (refer to FIG. 2) supporting TCP/IP as described above, thereby enabling the information processors 100 and 200 to send data to and/or receive data from each other.

The information processors 100 and 200 and the pointer 300 are connected to each other through a wireless network such as a Bluetooth network, thereby enabling them to send data to and/or receive data from each other.

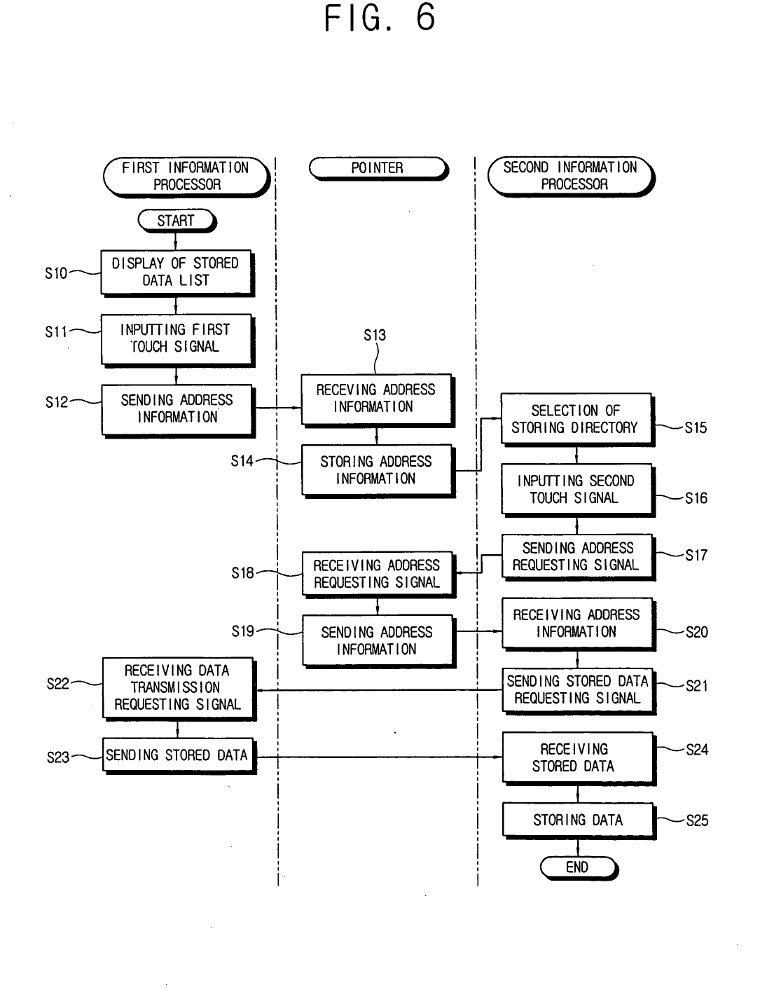

Hereinbelow, a data transmission method according to an embodiment of the present invention is described referring to FIGS. 5 and 6. To help understanding the present invention as shown in FIG. 5 of a data transmission system, an information processor to send stored data is defined as a first information processor 100, and an information processor to receive stored data from the first information processor 100 and store the received data is defined a second information processor 200. The touch screen interface 140, the wireless network module 160, and the transmission controller 170 of the first information processor 100 are defined as a first touch screen interface, a first wireless network module, and a first transmission controller, respectively and reference numbers are given as shown in FIG. 2. A structure of the second information processor 200 corresponds to a structure of the information processor shown in FIG. 2. The touch screen interface 240, the wireless network module 260, and the transmission controller 270 of the second information processor 200 are defined as a second touch screen interface, a second wireless network module, and a second transmission controller, respectively and reference numbers are given as 240, 260 and 270, respectively, to distinguish them from the components 140, 160, and 170 of the first information processor 100. The wireless network module, and the transmission controller of the pointer device 300 are defined as a third wireless network module 360, and a third transmission controller 370.

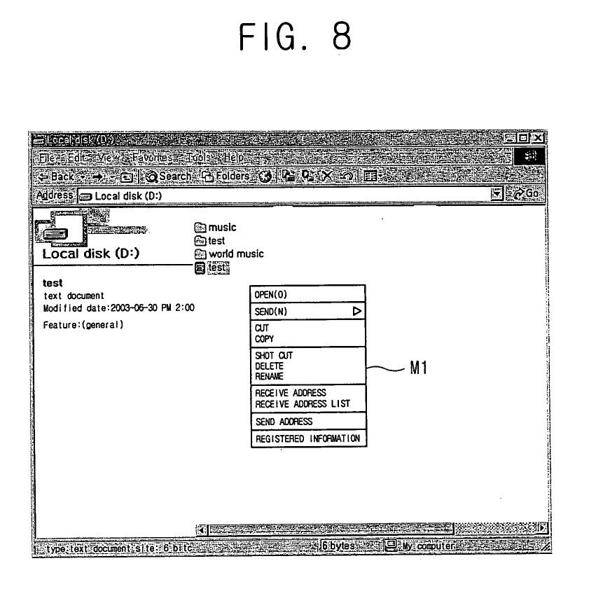

First, when the first information processor 100 is turned on, a list of data stored in the data storage 190 of the first information processor 100 is displayed on the display 150 by operating the first touch screen interface 140 or an input device such as a keyboard at operation S10. Then, a user selects one of the displayed data using the pointer 300 or a pen that is separate from the pointer 300. and the user then inputs a first touch signal using the first touch screen interface 140 to transmit address information of the selected data at operation S11. FIG. 8 shows an example how to input the first touch signal. As shown, the user touches the touch screen pad 142 with a predetermined pressure for a predetermined time using the pointer 300 or a pen so that a menu selecting window Ml is displayed showing a number of selection menus. Then, the selection menu corresponding to the input of the first touch signal (“address transmission” in FIG. 8) is selected.

If the first touch signal is input from the first touch screen interface 140, the first transmission controller 170 reads the address information of the selected data corresponding to the first touch signal and transmits the address information to the pointer 300 through the first wireless network module 160 at operation S12. Here, if the network between the first and second information processors 100 and 200 supports TCP/IP, the address information transmitted to the pointer 300 includes IP address information of the first information processor 100, directory information of the selected data in the first information processor 100, and file information of the selected data. Thus, through the address information, the second information processor 200 recognizes an exact position of the stored data required to be transmitted on a network.

If address information is received from the first information processor 100 through the third wireless network module 360 at operation S13, the third transmission controller 370 of the pointer 300 stores the received address information in the third address storage 350 at operation S14.

When address information is stored in the third address storage 350 of the pointer 300, the user selects a position, such as a directory, to which the data is transmitted, at operation S15. The position is selected using the second information processor 200, the pointer 300, or the pen. The user then inputs a second touch signal, using the second touch screen interface 240, to request transmission of the address information stored in the pointer 300. FIG. 8 shows an example of how to input the second touch signal in the second information processor 200. The user touches the touch screen pad 142 with a predetermined pressure for a predetermined time using the pointer 300 or the pen so that a menu selection window M1 is displayed showing a number of selection menus. Then, the selection menu corresponding to the input of the second touch signal (“address reception” in FIG. 8) is selected.

Thereafter, if the second touch signal is input from the second touch screen interface 240, the second transmission controller 270 transmits an address requesting signal to the pointer 300 through the second wireless network module 260 to request transmission of the address information stored in the pointer 300 at operation S17.

Then, if the address requesting signal is received from the second information processor 200 through the third wireless network module 360 at operation S18, the transmission controller 370 of the pointer 300 reads out the address information stored in the pointer 300 and transmits the address information to the second information processor 200 through the wireless network module 360 at operation S19. In the data transmission method according to an embodiment of the present invention, the address information stored most recently among the address information stored in the third address storage 350 is transmitted to the second information processor 200 according to the address requesting signal. Here, the address information stored most recently corresponds to the transmitted address information from the first information processor 100. Thus, the address information stored most recently is single address information if the first information processor 100 selects single data and transmits single address information of the selected data. The address information stored most recently are a plurality of address information if the first information processor 100 selects a plurality of data at the same time and transmits address information of the selected data. In the data transmission method according to an embodiment of the present invention, if address information is transmitted from the first information processor 100, the third transmission controller 370 may eliminate the address information previously stored in the address storage 350 and update it to the address information recently received. Thus, the address information received most recently is stored in the third address storage 350.

If the address information is received from the pointer 300 at operation S20, the second transmission controller 270 transmits a data requesting signal to the first information processor 100 to request transmission of data stored in the first information processor 100 corresponding to the received address information at operation 21. Here, the data requesting signal is transmitted through the network 400 that connects the first and second information processors 100 and 200.

If the data requesting signal is received from the second information processor 200 at operation S22, the first transmission controller 170 reads data from the data storage 190 that corresponds to the data requesting signal and sends the data to the second information processor 200 through the network 400 that connects the first and second information processors 100 and 200 at operation S23.

if the stored data is received from the first information processor 100 through the network 400 at operation S24, the second transmission controller 270 stores the received data in a sector of the data storage 290 corresponding to the directory selected through the touch screen interface, at operation S25, thereby completing transmission of data from the first information processor 100 to the second information processor 200 and storage of the data.

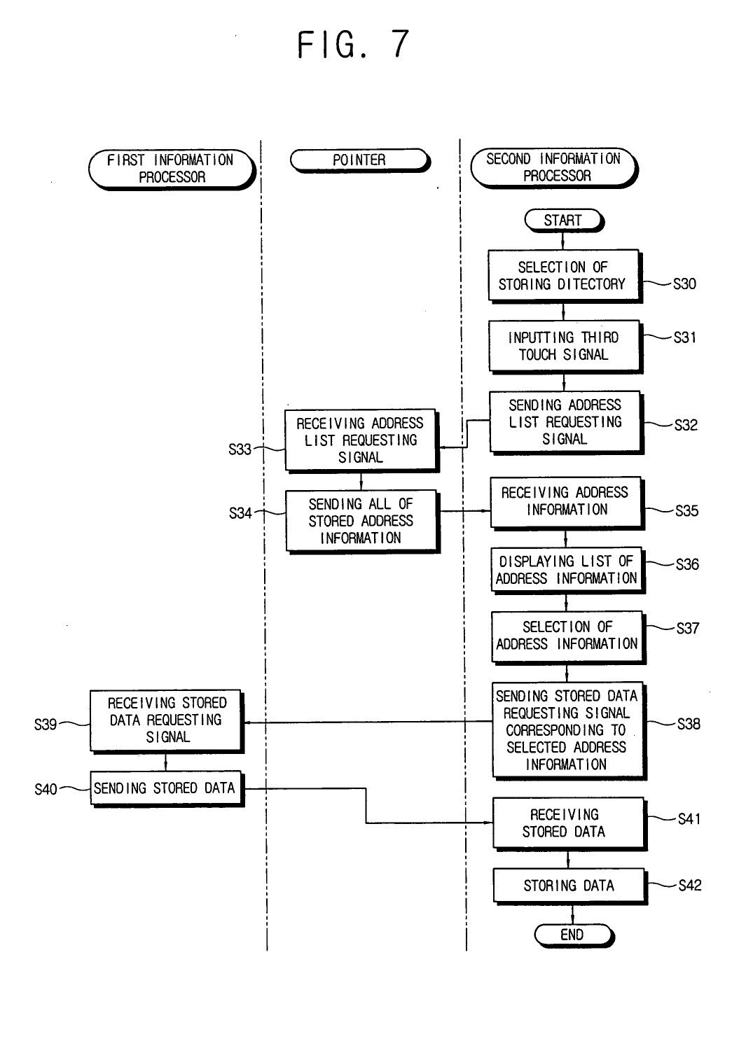

FIG. 7 is a control flow chart of a data transmission method according to another embodiment of the present invention. The data transmission method according to this embodiment of the present invention is described below, referring to FIGS. 5 and 7. Here, the operations S10 through S14, as shown in FIG. 6, in the data transmission method according to the previously detailed embodiment of the present invention are likewise employed in the data transmission method according to the current embodiment of the present invention and thus a description thereof will be omitted.

If the address information is already stored in the address storage 350 of the pointer 300, the user selects a directory of the second information processor 200 to which data is transmitted using the pointer 300 or the pen at operation S30. Then, the user inputs a third touch signal through the second touch screen interface 240 to request transmission of the address information stored in the pointer 300 at operation S31. Here, the third touch signal is an input signal to request transmission of all of the address information stored in the address storage 350. Here, “all of address information” refers to every address information the pointer 300 stores therein regardless of the order in which the address information is stored in the address storage 350. The method of how the third touch signal is input in the second information processor 200 is similar to the input method of the second touch signal described above. The selection menu corresponding to the input of the third touch signal (“address list reception” in FIG. 8) is selected in the menu selecting window M1 shown in FIG. 8.

If the third touch signal is input from the second touch screen interface 240, the second transmission controller 270 transmits an address list requesting signal to the pointer 300 through the second wireless network module 260 to request transmission of all of the address information stored in the pointer 300 at operation 32.

Thereafter, if the address list requesting signal is received from the second information processor 200 through the third wireless network module 360 at operation S33, the third transmission controller 370 reads out all of the address information stored in the address storage 350 and transmits it to the second information processor 200 through the third wireless network module 360 at operation S34. The third transmission controller 370 stores the address information previously stored in the address storage 350 together with the address information newly stored in the address storage 350, if the address information is received from the first information processor 100.

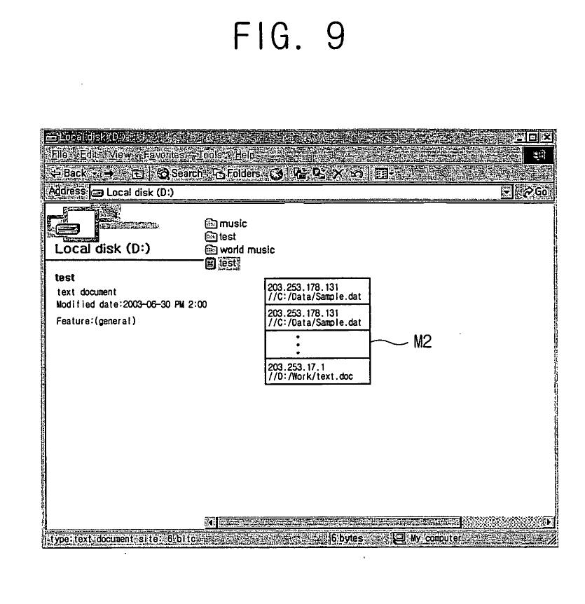

Then, as shown in FIG. 9, if the address information is received from the pointer 300 at operation S35, the second transmission controller 270 of the second information processor 200 displays a list of the received address information M2 on the display 150 at operation S36. The user selects at least one of the displayed address information listed M2 by using the pointer 300 or the pen at operation S37. The second transmission controller 270 then transmits a stored data requesting signal to the first information processor 100 to request transmission of the data stored in the first information processor 100 that corresponds to the selected address information. The stored data requesting signal is transmitted through the network 400 that connects the first and second information processors 100 and 200 at operation S38.

Then, if the stored data requesting signal is received from the second information processor 200 at operation S39, the first transmission controller 170 reads the stored data that corresponds to the stored data requesting signal from the data storage 190 and transmits the stored data to the second information processor 200 through the network 400 that connects the first and second information processors 100 and 200 at operation S40.

If the stored data is received from the first information processor 100 through the network 400 at operation S41, the second transmission controller 270 stores the stored data in the second data storage 290, thereby completing transmission of data from the first information processor 100 to the second information processor 200 and storage of the data.

The third transmission controller 370, according to an aspect of the present invention, eliminates address information stored in the address storage 350 after a predetermined time from the point that the address information is transmitted from the first information processor 100. The third transmission controller 370 transmits address information to the second information processor 200 according to a request of the second information processor 200and eliminates the transmitted address information from the address storage 350. Hence, the storage capacity of the address storage 350, which is limited, is effectively managed.

The information processor according to an aspect of the present invention is applied to not only a desktop computer, a portable computer such as a laptop computer, or a PDA (personal digital assistants), but can also be applied to all information processors such electronic organizers or portable terminals, as long as the information processors can send, receive, and/or store data therein.

In the embodiments described above, the network between the information processors 100 and 200 supports TCI/IP. However, a different network protocol may be employed in which data is transmitted between the information processors 100 and 200 and data is accessed based on position data stored in the information processor such as the address information in the TCP/IP, described above.

According to an aspect of the present invention, the first transmission controller 170 may have a function of the second transmission controller 270, and the second transmission controller 270 may have a function of the first transmission controller 170, so that the first and second information processors 100 and 200 send data to and/or receive data from each other.

An embodiment of the present invention arises such that the first and second information processors 100 and 200 send data to and/or receive data from each other, the data transmission system comprising: a first information processor and a second information processor connected with each other through a network, and having touch screen interfaces; and a pointer that wirelessly sends data to and/or receives data from the first information processor and the second information processor is provided, and the first information processor transmits address information of data previously stored to the pointer, the data corresponds to a first touch signal input through the touch screen interface, the pointer stores address information received from the first information processor and transmits the stored address information to the second information processor, if an address requesting signal is received from the second information processor, and the second information processor receives stored data from the first information processor and stores the received data, the stored data corresponds to the address information received from the pointer. Thus, the interface conveniently transfers stored data between the information processors that is then be supplied to the user.

in the present invention, a process to set up a network environment is not required as in the conventional data transmission system using the conventional Windows Explorer, so that a normal user having only minimal knowledge of networking can transmit data with ease.

Moreover, although the user doesn't know the exact IP address information of the information processor storing data required to be transmitted or the exact directory information in which a file is stored, the user can transmit data.

Further, only the address information of the stored data required to be transmitted is stored in the pointer, so that the address storage of the pointer has a greater storage capacity. Data transmission between information processors that are separated from each other is accomplished with ease by using the pointer, which is easy to carry.

As described above, the present invention provides a data transmission system, a data transmission method, an information processor, and a pointer which provides a user with a convenient interface to transmit stored data between information processors by wirelessly sending data to and/or receiving data from the information processors.

Although a few embodiments of the present invention have been shown and described, it will be appreciated by those skilled in the art that changes may be made in these embodiments without departing from the principles and spirit of the invention, the scope of which is defined in the claims and their equivalents.

1. A data transmission system comprising:
a first information processor and a second information processor connected with each other through a network and having interfaces; and
a pointer that wirelessly sends data to and/or receives data from the first information processor and the second information processor,
wherein the first information processor transmits address information of data previously stored to the pointer, the data corresponding to a first signal input through the interface of the first information processor,
the pointer stores the address information received from the first information processor and transmits the stored address information to the second information processor, if an address requesting signal is received from the second information processor, and
the second information processor receives stored data that corresponds to the address information received from the pointer from the first information processor and stores the received data.

2. The data transmission system according to claim 1, wherein the first information processor comprises:
a first data storage to store at least one data;
a first wireless network module to transmit the address information; and
a first transmission controller to read the address information of the data previously stored according to the first signal and transmit the read address information through the first wireless network module.

3. The data transmission system according to claim 2, wherein the first transmission controller is an application based on an operation system of the first information processor.

4. The data transmission system according to claim 2, wherein the second information processor comprises:
a second wireless network module to receive the address information transmitted from the pointer;
a second transmission controller to transmit the address requesting signal through the second wireless network module, the address requesting signal corresponding to a second signal input through the interface of the second signal processor; and
a second data storage to store the stored data transmitted from the first information processor.

5. The data transmission system according to claim 4, wherein the second transmission controller is an application based on an operating system of the second information processor.

6. The data transmission system according to claim 4, wherein the second transmission controller transmits the address requesting signal through the second wireless network module.

7. The data transmission system according to claim 6, wherein the second transmission controller transmits a stored data requesting signal to the first information processor to request transmission of the stored data corresponding to the received address information if the address information is received from the pointer.

8. The data transmission system according to claim 7, wherein the pointer comprises:
a third wireless network module to wirelessly send data to and/or receive data from the first wireless network module and the second wireless network module;
an address storage to store address information received from the first information processor through the third wireless network module; and
a third transmission controller to sense if the address requesting signal is received from the second information processor through the third wireless network module and transmit the address information stored in the address storage to the second information processor through the third wireless network module.

9. The data transmission system according to claim 8, wherein the third transmission controller reads and transmits the address information stored most recently among the address information stored in the address storage, if the third transmission controller senses that the address requesting signal is received.

10. The data transmission system according to claim 9, wherein the second transmission controller transmits an address list requesting signal through the second wireless network module, the address list requesting signal corresponding to a third signal input through the interface of the second information processor,
the third transmission controller reads out and transmits all of address information stored in the address storage, if the address list requesting signal is received.

11. The data transmission system according to claim 10, wherein the second transmission controller displays a list of address information received from the pointer, corresponding to the address list requesting signal, and transmits the stored data requesting signal to the first information processor to request transmission of the stored data corresponding to the address information selected through the interface of the second information processor.

12. The data transmission system according to claim 1, wherein the first information processor, the second information processor, and the pointer wirelessly transfer data through one of a Bluetooth protocol and a wireless LAN protocol.

13. The data transmission system according to claim 1, wherein the network connecting the first information processor and the second information processor supports a TCP/IP protocol.

14. The data transmission system according to claim 13, wherein the address information comprises IP address information of the stored data corresponding to the address information, directory information in the first information processor, and file information of the stored data.

15. The data transmission system according to claim 1, wherein at least one of the interfaces of the first information processor and the second information processor is a touch screen interface.

16. The data transmission system according to claim 4, wherein the second transmission controller displays a list of the address information received from the pointer.

17. The data transmission system according to claim 12, wherein the Bluetooth network comprises:
an RF sender to send a data packet according to Bluetooth protocol;
an RF receiver to receive a data packet according to Bluetooth protocol;
a base band processor to modulate a signal sent from the RF sender and demodulate a signal received by the RF receiver, and
a module controller to control the operation of the Bluetooth network.

18. The data transmission system according to claim 8, wherein the third transmission controller is firmware stored in a chip.

19. A data transmission method between a first information processor and a second information processor connected to each other through a network and having an interface to input a signal therein, the data transmission method comprising:
wirelessly send data to and/or receive data from the first information processor and the second information processor using a pointer;
inputting a first signal to transmit address information through the interface of the first information processor;
transmitting address information of stored data to the pointer according to the first signal, the stored data being data from among data previously stored in the first information processor,
storing the transmitted address information in the pointer;
transmitting the stored address information to the second information processor according to a request from the second information processor;
transmitting the data stored in the first information processor to the second information processor, the transmitted data corresponding to the transmitted address information; and
storing the stored data transmitted from the first information processor in the second information processor.

20. The data transmission method according to claim 19, wherein the transmitting the stored address information to the second information processor according to a request from the second information processor comprises:
inputting a second signal through the interface of the second information processor to request transmission of the address information stored in the pointer,;
transmitting an address requesting signal corresponding to the second signal from the second information processor to the pointer; and
transmitting the address information stored in the pointer from the pointer to the second information processor, if the address requesting signal is received by the pointer.

21. The data transmission method according to claim 20, wherein the address information transmitted in the transmitting the address information stored in the pointer from the pointer to the second information processor corresponds to the address requesting signal and is the address information stored most recently in the pointer.

22. The data transmission method according to claim 20, wherein the transmitting the stored address information to the second information processor according to a request from the second information processor comprises:
inputting a third signal through the interface of the second information processor;
transmitting an address list requesting signal corresponding to the second signal from the second information processor to the pointer; and
transmitting all of address information stored in the pointer from the pointer to the second information processor, if the address list requesting signal is received by the pointer.

23. The data transmission method according to claim 22, further comprising:
receiving address information corresponding to the address list requesting signal into the second information processor from the pointer;
displaying a list of the received address information; and
selecting at least one address information of the list of the displayed address information,
wherein the stored data transmitted from the first information processor to the second information processor in the transmitting the data stored in the first information processor to the second information processor comprises the stored data corresponding to the address information selected in the inputting a first signal to transmit address information through the interface of the first information processor.

24. The data transmission method according to claim 19, wherein the transmitting the data stored in the first information processor to the second information processor comprises:
receiving address information transmitted from the pointer into the second information processor;
transmitting a data requesting signal to the first information processor to request transmission of data stored in the first information processor, the stored data corresponding to the received address information; and
transmitting stored data corresponding to the data requesting signal from the first information processor to the second information processor.

25. The data transmission method according to claim 19, wherein the first information processor, the second information processor, and the pointer wirelessly transfer data through one of a Bluetooth protocol and a wireless LAN protocol.

26. The data transmission method according to claim 19, wherein the network connecting the first information processor and the second information processor supports a TCP/IP protocol.

27. The data transmission method according to claim 26, wherein the address information comprises IP address information of the stored data corresponding to the address information, directory information in the first information processor, and file information of the stored data.

28. The data transmission method according to claim 21, wherein the address information stored most recently is single address information if the first information processor selects single data and transmits single address information of the selected single data, and the information stored most recently is plural address information if the first information processor selects a plurality of data and transmits the address information of the selected plurality of data at the same time.

29. The data transmission method according to claim 21, wherein if address information is transmitted from the first information processor, the third transmission controller eliminates any address information previously stored in the address storage.

30. An information processor comprising:
a system main body comprising: a first wireless network module, an interface to input a signal therein, a data storage to store at least one data therein, and a first transmission controller to transmit address information of stored data through the first wireless network module, the stored data corresponding to the signal input through the interface; and
a pointer comprising: a second wireless network module that sends data to and/or receives data from the first wireless network module, an address storage to store address information received from the second wireless network module, and a second transmission controller to read address information stored in the address storage according to a request of an external information processor, and transmit the address information to the external information processor.

31. The information processor according to claim 30, wherein the first transmission controller reads stored data corresponding to the address information from the data storage and transmits the read data to the external information processor, if there is a request of the external information processor that receives the address information from the pointer.

32. The information processor according to claim 30, wherein the first wireless network module and the second wireless network module wirelessly transfer data with each other through a Bluetooth protocol.

33. A pointer comprising:
a wireless network module to wirelessly transfer data with a first information processor and a second information processor;
an address storage to store address information of data stored in the first information processor, the address information is received from the first information processor through the wireless network module; and
a transmission controller to transmit the address information stored in the address storage to the second information processor through the wireless network module, if address requesting signal is received from the second information processor through the wireless network module.

34. The pointer according to claim 33, wherein the wireless network module supports a Bluetooth protocol.
